(19) United States
(12) Patent Application Publication
(10) Pub. No.: US 2007/0279382 A1
(43) Pub. Date: Dec. 6, 2007

(54) COMBINATION TRAVEL AND WORK MOUSE

(76) Inventor: William Thomas Large, Long Beach, NY (US)

Correspondence Address: MEREDITH & KEYHANI, PLLC, 330 MADISON AVE., 6TH FLOOR, NEW YORK, NY, 10017, US

(21) Appl. No.: 11/738,879

(22) Filed: Apr. 23, 2007

Related U.S. Application Data
(60) Provisional application No. 60/745,410, filed on Apr. 23, 2006.

(51) Int. Cl. G06F 3/033

(52) U.S. Cl. 345/163

(57) ABSTRACT

A dual size mouse apparatus comprising: a first outer shell with: a base to be placed on a working surface and with an inner cavity shaped to receive a second inner mouse and having at least one outer shell contact device; a first raised portion and a second raised housing; a second inner mouse having; a base to be placed on a working surface and containing mousing components; at least one inner mouse raised portion with at least one inner shell contact device corresponding to each at least one outer shell contact device to detect mousing when the second inner mouse is attached to the second inner mouse, wherein the second inner mouse is capable of mousing alone and the first outer shell works as a mouse when the outer shell contact device is in communication with at least one inner shell contact device.

This application claims priority to application No. 60/745,410 filed Apr. 23, 2006 entitled “Combination Travel and Work Mouse”. The present invention related generally to mouse devices and in particular to a mouse the provide a large ergonomic mouse for home or office use as well as a smaller travel mouse.

### BACKGROUND OF INVENTION

Most use laptops and therefore either use the onboard mouse navigation device or a travel mouse. The cost of buying 3 mice, one for home, one for office and a travel mouse when away from both will likely mean compromise on important ergonomic issues.

When you are traveling a conventional palm down mouse when used sparingly may not present a great risk and therefore a contemporary or palm down small portable mouse could be used. However when in the work or home environment, or when traveling for work, it is more likely and usual to work for more than two hours per day, a better ergonomic design is required. The present invention cost effectively facilitates such a requirement.

It also allows for easier manufacturing in regards to dexterity, in that the customer buys the basic functional mouse module and then chooses a left or right handed “mouse shell” and can opt to buy more than one for use in the office and one for home. The basic module or a travel mouse in another iteration could have “shell” selections for either dexterity or other design preference.

Additionally, it is possible in the home with a single computer installation for example that “shells” of different sizes could be used by persons of different hand sizes, reducing the cost of having many mice as the shell, without the expensive optical detection system, would be more affordable.

The prior art goes someway towards recognizing the comfort (not safety) of a larger mouse, though still palm down. They do not however provide separate shells as an option so anticipate that the clip on unit they provide will be carried at all times by the user if they are to use it when at home or in the office. This does not anticipate “forgetful” human behavior, or the desire to “travel light” and minimize the number of accessories when traveling. The present invention envisions shell devices that are left at the computers you routinely visit and use and are interchangeable.

Neither does the prior art allow for the fact that an effective anti-fatigue mouse must in its design be larger than the more fatiguing palm down wrist twisting devices, which makes such a design less practical to transport for reasons stated, despite the proven ergonomic benefits. This invention does however recognize the location of the greatest risk factors, the office and the “home office” and accommodates that risk at a lower average unit cost and with more user options. Those being shell choices of dexterity; left or right, and within that option hand size and even input device design, such as making a travel mouse into a trackball.

It satiates that need by utilization the optical assembly and processing chips on board the Travel Mouse, the most expensive components in all the product permutations. In one iteration the shells themselves only require mouse button or scroll wheel emulation.

Another iteration (and invention) is to produce an even more low cost shell without any button/wheel emulation that utilizes software based button/wheel functionality that does not require the presence, on a mouse, input or screen navigation device, of physical buttons or scroll wheels.

Likewise shell designs are not limited to a “conventional” mouse design, but shells could be configured and designed as, in one example, a trackball, or other such devices commonplace to computer input.

Neither does the prior art allow for the fact that an effective anti-fatigue mouse must in its design be larger than the more fatiguing palm down wrist twisting devices, which makes such a design less practical to transport for reasons stated, despite the proven ergonomic benefits. This invention does however recognize the location of the greatest risk factors, the office and the “home office” and accommodates that risk at a lower average unit cost and with more user options. Those being shell choices of dexterity; left or right, and within that option hand size and even input device design, such as making a travel mouse into a trackball.

It satiates that need by utilization the optical assembly and processing chips on board the Travel Mouse, the most expensive components in all the product permutations. In one iteration the shells themselves only require mouse button or scroll wheel emulation.

Another iteration (and invention) is to produce an even more low cost shell without any button/wheel emulation that utilizes software based button/wheel functionality that does not require the presence, on a mouse, input or screen navigation device, of physical buttons or scroll wheels.

Likewise shell designs are not limited to a “conventional” mouse design, but shells could be configured and designed as, in one example, a trackball, or other such devices commonplace to computer input.

Accordingly, there is a need within the prior art to provide a dual use mouse that can provide a larger ergonomic shell and a smaller inner travel shell.

### BRIEF DESCRIPTION OF THE DRAWINGS

FIG. 1 depicts the present invention;

FIG. 2 depicts the present invention;

FIG. 3 depicts the present invention; and

FIG. 4 depicts the present invention.

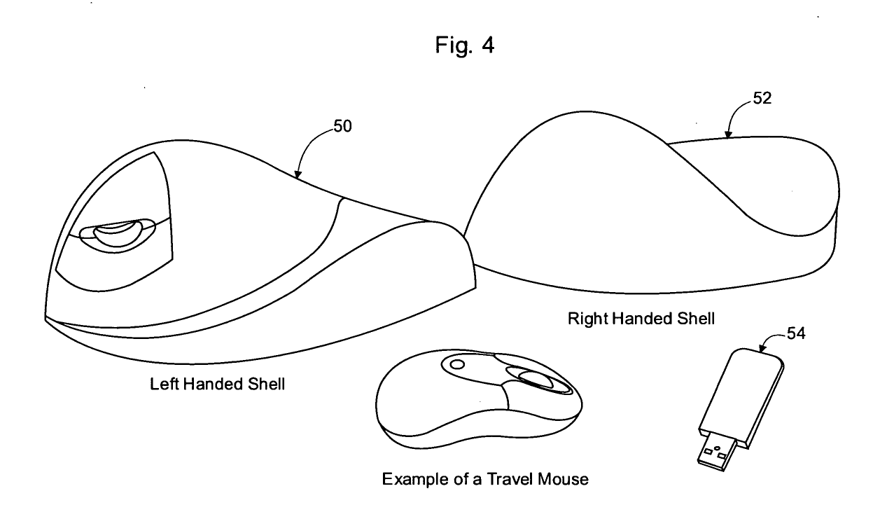

### DETAILED DESCRIPTION OF THE INVENTION

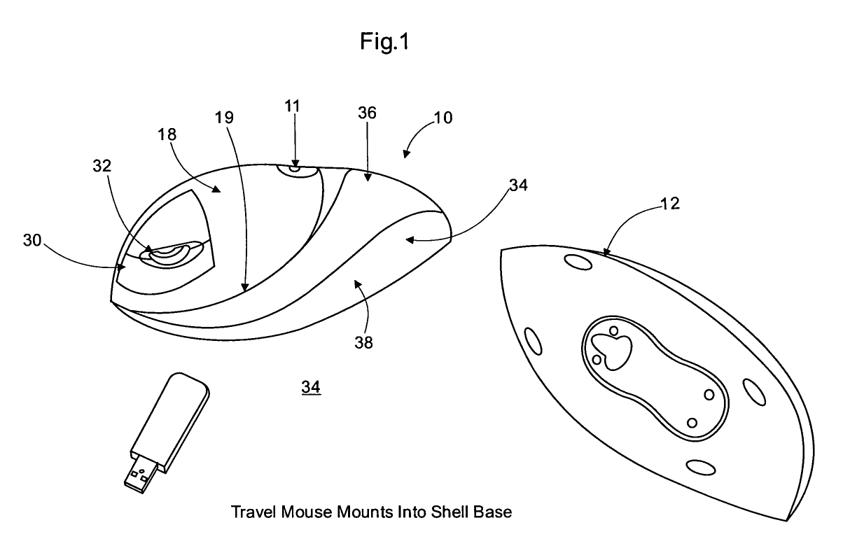

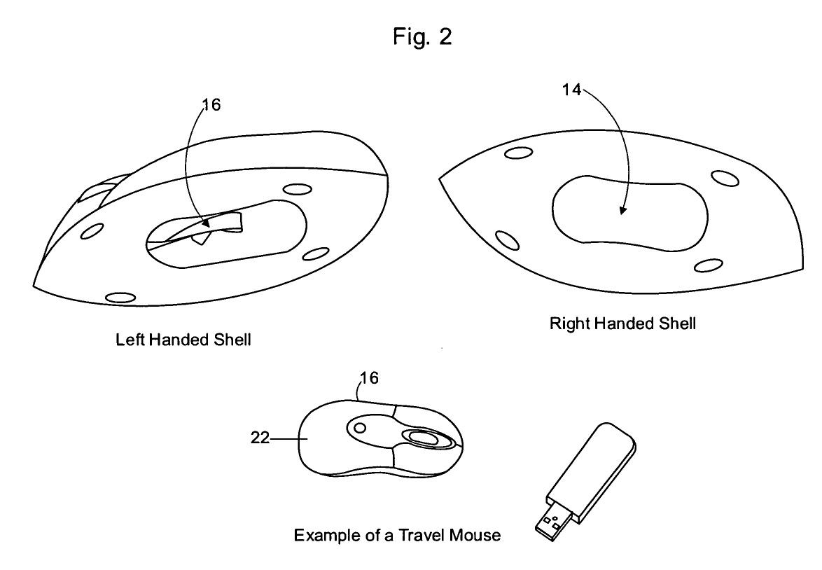

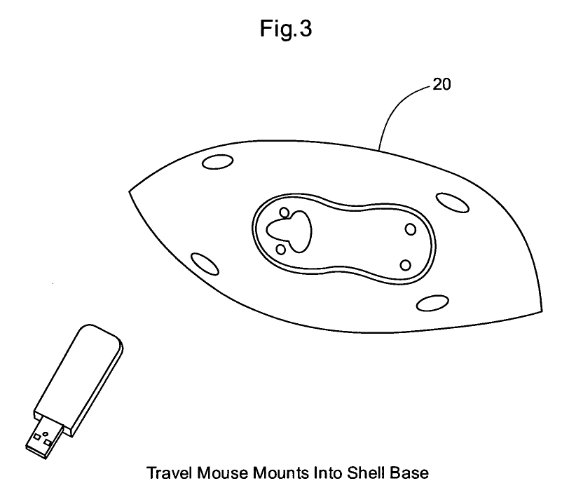

A dual size mouse apparatus, as depicted in FIGS. 1-3, the apparatus 10 comprising: a first outer shell 11, the first outer shell 11 comprising: a base 12, configured to be placed on a working surface, and having an inner cavity 14 shaped to receive a second inner mouse 16, wherein the inner cavity has at least one outer shell contact device contained therein; at least one outer shell raised portion 18 for receipt of a users hand; a second inner mouse 16, comprising: a base 20 configured to be placed on a working surface 34 and containing mousing components; at least one inner mouse raised portion 20, wherein the inner mouse raised portion 20 has at least one inner shell contact device which corresponds to each the at least one outer shell contact device to detect mousing when the first outer shell 11 is attached to the second inner mouse 16, wherein the second inner mouse 16 is capable of mousing alone and the first outer shell 11 works as a mouse when the outer shell contact device is in communication with the at least one inner shell contact device. The contact device may be any device capable of sensing the second inner mouse 16 being attached to the first outer shell 11. Examples of contact devices may be contact device is selected from the group consisting of contact pads, optical sensors, infrared sensors and light emitting diode. The first outer shell may be further comprised of at least one actuation device (e.g. buttons 30, 32).

The first outer shell 11 may be ergonomically shaped, as shown in FIGS. 1-3 and having a first raised portion 18, wherein the first raised portion has an inner surface (19) and an outer surface (not visible, side opposing inner surface 19); and a second raised housing 34 with a second inner surface 36 and a second outer surface 38. The second raised housing 34, as shown, is shaped to receive a mouse users palm in a handshake position.

The mousing components are selected from the group consisting of a mouse ball, light emitting diode, complimentary metal oxide semiconductor (CMOS) sensor, roller, x-roller, y-roller, shaft, disk, optical encoding disk, on-board processor chip, encoder chip and processor. It is preferred that the mousing components are contained within the second inner mouse 16. In this manner, the expensive mousing components may be used for both the second inner mouse 16 and first outer shell 11 to provide to distinct mousing devices. The first outer device being larger and ergonomic. The second inner mouse 16 being appropriate for travel (and may or may not be ergonomic).

The present invention envisions a first outer shell 11 that is left handed 50 or right handed 52 without departing from the present invention. It is also envisioned that the mouse may be wired or wireless 54, as shown.

This description is not to be taken in a limiting sense, but is made merely for the purpose of illustrating the general principles of the invention, since the scope of the invention is best defined by the appended claims.

I claim:

1. A dual size mouse apparatus, said apparatus comprising:
a first outer shell, said first outer shell comprising:
a base, configured to be placed on a working surface, and having an inner cavity shaped to receive a second inner mouse, wherein said inner cavity has at least one outer shell contact device contained therein;
at least one outer shell raised portion for receipt of a users hand;
a second inner mouse, said second inner mouse comprising:
a base configured to be placed on a working surface and containing mousing components;
at least one inner mouse raised portion, wherein said inner mouse raised portion has at least one inner shell contact device which corresponds to each said at least one outer shell contact device to detect mousing when said first outer shell is attached to said second inner mouse,
wherein said second inner mouse is capable of mousing alone and said first outer shell works as a mouse when said outer shell contact device is in communication with said at least one inner shell contact device.

2. A dual size mouse apparatus as in claim 1, said apparatus comprising:
a first raised portion, wherein said first raised portion has an inner surface and an outer surface; and
a second raised housing with a second inner surface and a second outer surface;

3. A dual size mouse apparatus as in claim 1, wherein said second raised housing is shaped to receive a mouse users palm in a handshake position.

4. A dual size mouse as in claim 1, wherein said contact device is selected from the group consisting of contact pads, optical sensors, infrared sensors and light emitting diode.

5. A dual size mouse as in claim 1, wherein said mousing components are selected from the group consisting of a mouse ball, light emitting diode, complimentary metal oxide semiconductor (CMOS) sensor, roller, x-roller, y-roller, shaft, disk, optical encoding disk, on-board processor chip, encoder chip and processor.

6. A dual size mouse as in claim 1, wherein said first outer shell is further comprised of at least one actuation device.

7. A dual size mouse apparatus, said apparatus comprising:
a first outer shell, said first outer shell comprising:
a base, configured to be placed on a working surface, and having an inner cavity shaped to receive a second inner mouse, wherein said inner cavity has at least one outer shell contact device;
a first raised portion, wherein said first raised portion has an inner surface and an outer surface; and
a second raised housing with a second inner surface and a second outer surface;
a second inner mouse, said second inner mouse comprising:
a base configured to be placed on a working surface and containing mousing components;
at least one inner mouse raised portion, wherein said inner mouse raised portion has at least one inner shell contact device which corresponds to each said at least one outer shell contact device to detect mousing when said first outer shell is attached to said second inner mouse,
wherein said second inner mouse is capable of mousing alone and said first outer shell works as a mouse when said outer shell contact device is in communication with said at least one inner shell contact device.

8. A dual size mouse apparatus as in claim 7, wherein said second raised housing is shaped to receive a mouse users palm in a handshake position.

9. A dual size mouse as in claim 7, wherein said contact device is selected from the group consisting of contact pads, optical sensors, infrared sensors and light emitting diode.

10. A dual size mouse as in claim 7, wherein said mousing components are selected from the group consisting of a mouse ball, light emitting diode, complimentary metal oxide semiconductor (CMOS) sensor, roller, x-roller, y-roller, shaft, disk, optical encoding disk, on-board processor chip, encoder chip and processor.

11. A dual size mouse as in claim 7, wherein said first outer shell is further comprised of at least one actuation device.
